(19) United States
(12) Patent Application Publication
(10) Pub. No.: US 2012/0036300 A1
(43) Pub. Date: Feb. 9, 2012

(54) CONTROLLER AND ELECTRIC CONTROL UNIT INCLUDING THE SAME

(75) Inventor: Kenji MOCHIZUKI, Chita-gun (JP)

(73) Assignee: DENSO CORPORATION, Kariya-city (JP)

(21) Appl. No.: 13/204,926

(22) Filed: Aug. 8, 2011

(30) Foreign Application Priority Data
Aug. 6, 2010 (JP) 2010-177578

(51) Int. Cl. G06F 13/26; G06F 12/02

(52) U.S. Cl. 710/264; 711/103; 711/E12.008

(57) ABSTRACT

A controller capable of inhibiting storage of prescribed information associated with a control operation when the control operation cannot be normally performed, and resuming the storage immediately after the control operation has again become able to be normally performed. The controller includes determining means for determining whether or not the control operation can be normally performed on the basis of a power level of electrical power supplied to the controller, write-inhibiting means for setting a storage area for storing the information to a write-inhibited area in cases where it is determined that the control operation cannot be normally performed, and releasing means for releasing, as an interrupt process higher in priority than any other process, the write inhibited area in cases where it is determined after the setting of the storage area to the write-inhibited area that the control operation can be normally performed.

### CROSS-REFERENCE TO RELATED APPLICATION

This application is based on and claims the benefit of priority from earlier Japanese Patent Application No. 2010-177578 filed Aug. 6, 2010, the description of which is incorporated herein by reference.

### BACKGROUND

1. Technical Field

This invention relates to a controller that performs a control operation and stores prescribed information associated with the control operation in a memory.

2. Related Art

A conventional controller, as disclosed in Japanese Patent Application Publication No. 2003-104137, performs a control operation, and stores prescribed information associated with the control operation in a storage area in a memory (e.g., a RAM area in a nonvolatile RAM). The prescribed information may include a detection value from a sensor, a result value (a value indicative of a result) of the control operation, an intermediate operation result obtained in the course of the control operation, a learning value to be used as a result of the control operation in subsequent control operations, and failure information indicative of a failure that has occurred in a controlled object.

In the above controller, however, a decrease in power-supply voltage or the like will probably lead to an abnormal state such that the controller cannot be normally driven, thereby preventing the prescribed information from being normally stored in the memory. Therefore, it is required to detect such a state and inhibit storage of the prescribed information in the memory.

Since the state such that the controller cannot be normally driven doesn't necessarily mean a continuing problem, it is desirable to inhibit the storage of the prescribed information in the memory and resume the storage of the prescribed information in the memory immediately after the controller has returned to a normal state such that the controller can be normally driven.

The inhibition and resumption of storage of the prescribed information in the memory will be advantageous, especially when the prescribed information include the learning value to be used in subsequent control operations. This is because the subsequent control operations after the resumption can be performed on the basis of the latest prescribed information stored in the previous normal state.

However, in the conventional controller as described above, even after the controller has returned to the normal state such that the controller can be normally driven (or the control operation can be normally performed by the controller), the resumption of storage of the prescribed information in the memory may be preceded by another process depending on its processing load and processing priority. That is, there is a possibility that it is impossible to resume the storage of the prescribed information in the memory immediately after the controller has returned to the normal state.

In consideration of the foregoing, exemplary embodiments of the present invention are directed to providing a controller that can resume the storage of the prescribed information in the memory immediately after the controller has returned to the normal state such that the control operation can be normally performed by the controller.

### SUMMARY

In accordance with an exemplary aspect of the present invention, there is provided a controller including an operation memory having a storage area therein for storing prescribed information associated with a control operation.

The controller further includes: determining means for determining whether or not the control operation can be normally performed on the basis of a power level of electrical power supplied to the controller; write-inhibiting means for setting the storage area in the operation memory to a write-inhibited area in cases where it is determined by the determining means that the control operation cannot be normally performed; and releasing means for releasing, as an interrupt process higher in priority than any other process, the write inhibited area in cases where it is determined by the determining means after the setting of the storage area to the write-inhibited area that the control operation can be normally performed.

In the controller of the above embodiment, once the controller has returned to a normal state such that the control operation can be normally performed, the release of the write-inhibited area is most preferentially performed over the other processes to be performed on the controller as an interrupt process, which allows the storage of information associated with the control operation to be resumed immediately after the return to the normal state.

With this configuration, for example, when a learning value to be used as a result of each control operation in subsequent control operations is stored as the prescribed information associated with the control operation, the subsequent control operations are allowed to be performed on the basis of the learning value indicative of the latest result after the return to the normal state.

In the above embodiment, it can be determined whether or not the control operation can be normally performed by the controller, for example, by checking whether or not the power level of electrical power supplied to the controller is within a range required for the controller to normally perform the control operation. The controller may thus be configured to determine whether or not the control operation can be normally performed by the controller directly monitoring the electrical power from the power supply source. Alternatively, the controller may be configured to indirectly determine whether or not the control operation can be normally performed on the basis of a notification signal from another monitoring entity that monitors the electrical power from the power supply source.

In the above embodiment, the releasing means for releasing the write-inhibited area may be implemented in software where the release of the write-inhibited area is prioritized over the other processes to be performed on the controller. Therefore, even if any one of the other processes is being performed, the release of the write-inhibited area is most preferentially performed as an interrupt process.

### BRIEF DESCRIPTION OF THE DRAWINGS

In the accompanying drawings:

FIG. 1 schematically illustrates a block diagram of an ECU in accordance with a first embodiment of the present invention;

FIG. 2 schematically illustrates a block diagram of a controller in accordance with the first embodiment;

FIG. 3 schematically illustrates settings of a storage area with variation of a voltage level in accordance with the first embodiment;

FIG. 4 schematically illustrates a flowchart of a memory protecting process in accordance with the first embodiment;

FIG. 5A schematically illustrates an address information storing process in accordance with the first embodiment;

FIG. 5B schematically illustrates a write-inhibiting process in accordance with the first embodiment;

FIG. 6A schematically illustrates voltage levels required for sensors and actuators to normally operate in accordance with a second embodiment;

FIG. 6B schematically illustrates settings of a storage area for each control operation with variation of a voltage level in accordance with the second embodiment of the present invention;

FIG. 7 schematically illustrates a block diagram of a controller in accordance with the second embodiment;

FIG. 8A schematically illustrates a flowchart of a first memory protecting process in accordance with the second embodiment; and

FIG. 8B schematically illustrates a flowchart of a second memory protecting process in accordance with the second embodiment.

### DESCRIPTION OF SPECIFIC EMBODIMENTS

The present invention will be described more fully hereinafter with reference to the accompanying drawings. Like numbers refer to like elements throughout.

(Configuration of ECU)

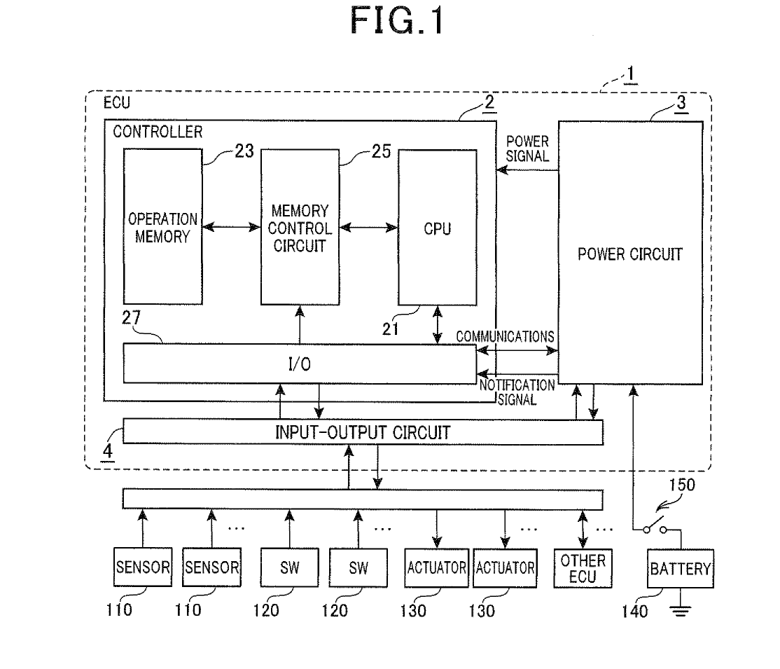

The ECU (electric control unit) 1, as shown in FIG. 1, includes a controller 2 that controls various actuators 130 on the basis of input signals from sensors 110 and switches (SWs) 120 (the sensors 110 and the switches 120 will be collectively referred to as “Sensors” hereinafter), a power circuit 3 that is supplied with electrical power from a battery 140 via a switch 150 and provides a power signal to the controller 2, and an input-output circuit 4 that relays input signals from the Sensors to the controller 2 and output signals from the controller 2 to the actuators 130.

In the present embodiment, the ECU 1 is mounted in a vehicle, and is operative to control the various actuators 130 on the basis of the input signals from the various Sensors to thereby control operations of the vehicle.

The controller 2 includes a CPU 21 that performs a process or processes required for each of a plurality of control operations, an operation memory 23 that stores programs for the control operations to be executed by the CPU 21 and processing results, a memory control circuit 25 between the CPU 21 and the operation memory 23, and an input-output interface (I/O) 27 that controls data communications between the controller 2 and the outside thereof.

The CPU 21 is further configured to store prescribed information associated with some of the control operations to be performed in the operation memory 23 in conjunction with processes required to perform the some of the control operations. The term “prescribed information” used herein may include a detection value from each sensor, a result value of each control operation, a learning value to be used as a result of each control operation in subsequent control operations, and failure information indicative of a failure that has occurred in a controlled object.

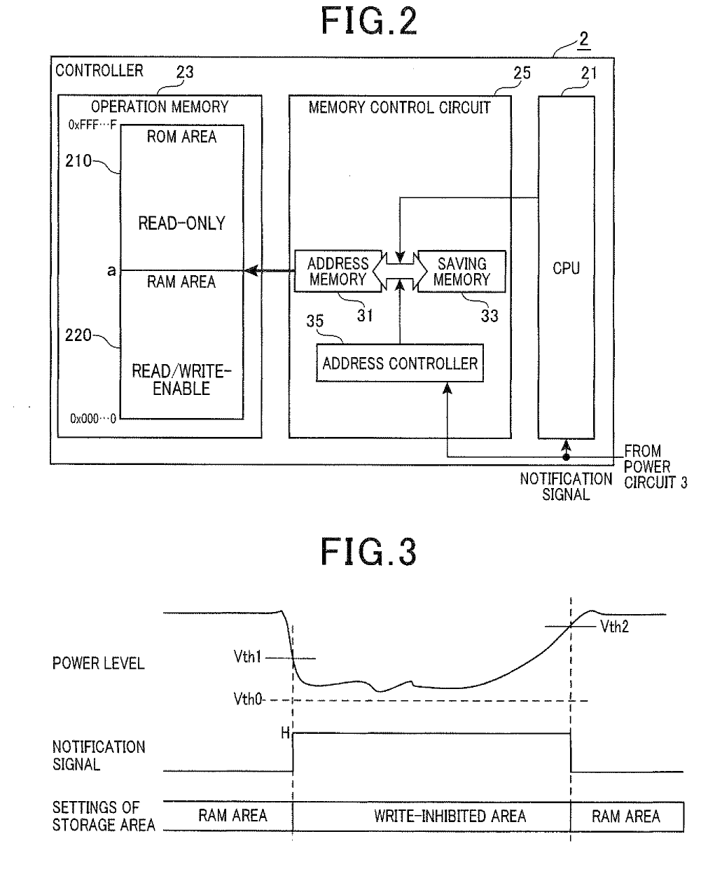

The operation memory 23 is a nonvolatile RAM that can define address ranges for a plurality of storage areas including at least a ROM area 210 for reading data only and a RAM area 220 for writing and reading data, as shown in FIG. 2. In the present embodiment, as shown in FIG. 2, the ROM area 210 and the RAM area 220 are defined by a border “a” (in boldface) therebetween.

The memory control circuit 25 as shown in FIG. 2 includes an address memory 31 that is a register for storing address information that defines address ranges in the operation memory 23, a saving memory 33 that is a register for saving the address information stored in the address memory 31, and an address controller 35 that controls the storage of the address information in the address memory 31 and the saving memory 33. The storage of the address information in the address memory 31 and the saving memory 33 may be controlled not only by the address controller 35, but also by instructions from the CPU 21.

In the present embodiment, address information that defines storage areas (practically, their address ranges) including a storage area allowed to store information associated with processes required for the control operations is initially stored in the address memory 31 in a memory protecting process, which will be described later.

In normal operation, the memory control circuit 25 relays data between the CPU 21 and the operation memory 23 on the basis of the address information stored in the address memory 31. More specifically, when the CPU 21 attempts to access to the operation memory 23 to only read data, the memory control circuit 25 reads the data from a storage area in the operation memory 23 and relays the read data from the operation memory 23 to the CPU 21. On the other hand, when the CPU 21 attempts to access to the operation memory 23 to write data therein, the memory control circuit 25 writes the data from the CPU 21 into a storage area in the operation memory 23 provided that that storage area exists in the RAM area 220 defined by the address information stored in address memory 31.

The power circuit 3 is supplied with electrical power from the battery 140, generates a power signal at a predetermined signal level, and provides the power signal to the controller 2. The power circuit 3 is configured to generate and provide the power signal to the controller 2 during a signal path being established by the switch 150 (e.g., being turned on), which switch may be an ignition switch in the present embodiment.

The power circuit 3 determines whether or not (the CPU 21 of) the controller 2 can normally perform the control operations on the basis of a power level of the battery 140. In cases where it is determined that the controller 2 cannot normally perform at least one of the control operations, the power circuit 3 outputs to the controller 2 a notification signal indicative of the at least one of the control operations being unable to be normally performed.

In the present embodiment, as shown in FIG. 3, the power circuit 3 monitors the power level of the battery 140, and in cases where the power level is below a range (Vth1, Vth2 in FIG. 3), in which range the power circuit 3 can generate the power signal at a suitable level, outputs to the controller 2 the notification signal at a H-level indicative of an abnormal state such that the controller 2 cannot be normally driven. In the “abnormal state such that the controller cannot be normally driven”, since the controller 2 is not supplied with the power signal at an adequate level, the controller 2 can neither perform a process or processes required for the determined control operation nor normally store information associated with the process or processes.

The power circuit 3 outputs a reset signal for restarting the controller 2 to the controller 2 in cases where the power level of the battery 140 is below a range in which the power circuit 3 can generate the power signal at a suitable level, and is further blow a level (Vth0 in FIG. 3) required to keep the controller 2 active.

(Memory Protecting Process)

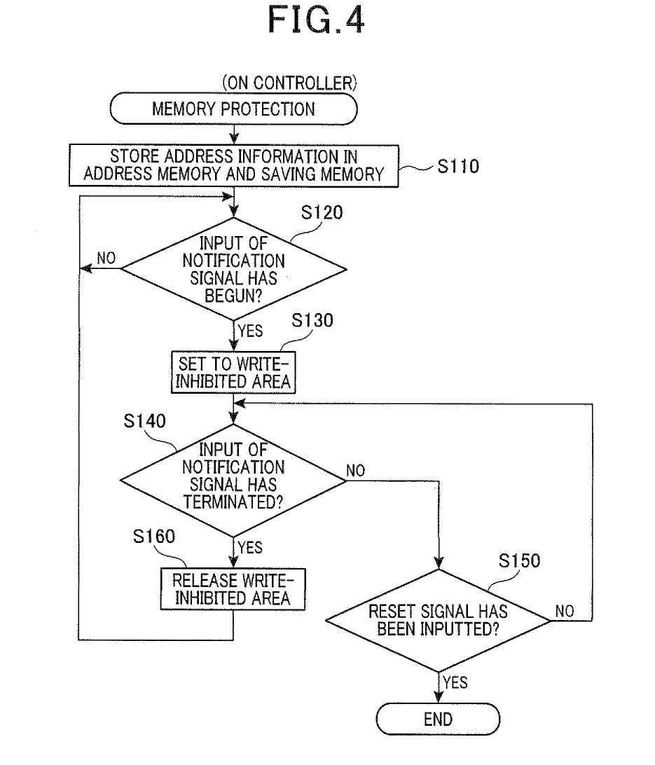

There will now be explained with reference to FIG. 4 a memory protecting process of the present embodiment to be performed by the CPU 21 of the controller 2 according to the programs stored in the ROM area 210 of the operation memory 23. The memory protecting process is iteratively (or repeatedly) performed after activation of the controller 2.

Once the memory protecting process is started, a plurality of pieces of address information stored in respective predefined storage areas in the ROM area 210 of the operation memory 23 are read out, and then stored in the address memory 31 and the saving memory 33 of the memory control circuit 25 respectively at step S110.

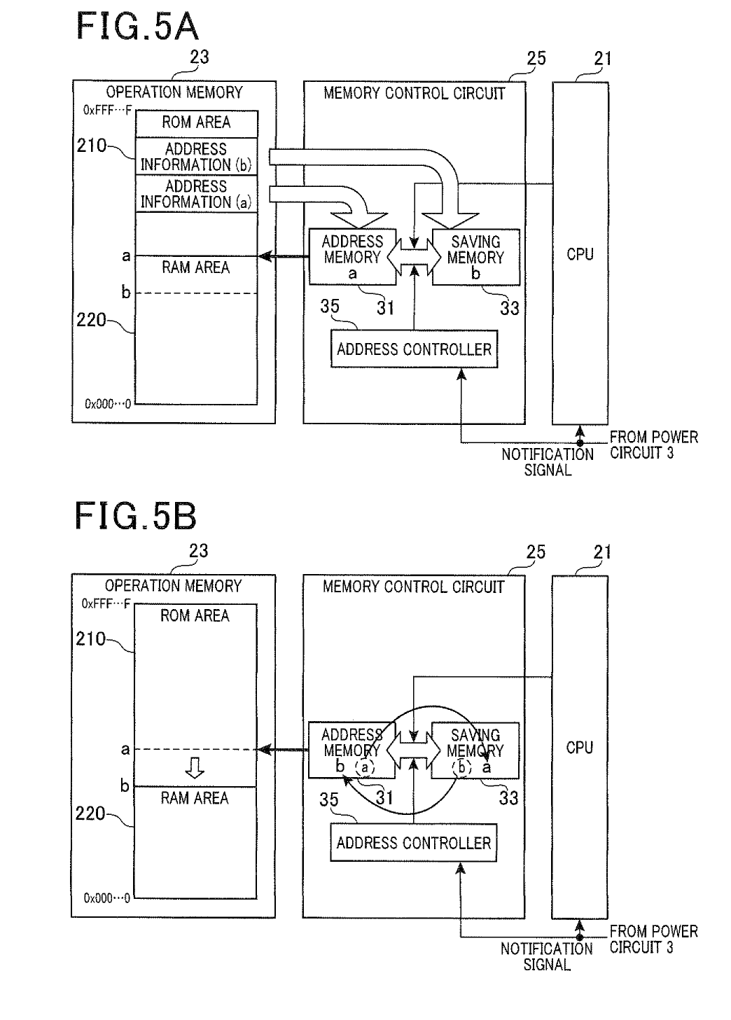

In the present embodiment, as shown in FIG. 5A, the plurality of pieces of address information stored in the predefined storage areas in the ROM area 210 include address information (a) and address information (b). The address information (a) defines the ROM area 210 and the RAM area 220 (the border therebetween in the present embodiment) when the control operations can be normally performed. The address information (b) defines the ROM area 210 and the RAM area 220 (the border therebetween in the present embodiment) when at least one of the control operations cannot be normally performed.

The former address information (a) defines the RAM area 220 as being composed of an entire storage area allowed to store information associated with processes required for the control operations (address range b to a in the present embodiment) and a storage area with smaller addresses (0x00 . . . 0 to b), and the ROM area 210 as being the remaining storage area in the operation memory 23.

The latter address information (b) defines the ROM area 210 as being composed of the entire storage area allowed to store information associated with processes required for the control operations (address range b to a) and a storage area with larger addresses (a to 0xFFF . . . F), and the RAM area 220 as being the remaining storage area in the operation memory 23.

Initially, at step S110, the former address information (a) is stored in the address memory 31, and the latter address information (b) is stored in the saving memory 33. The storage of the address information (a) in the address memory 31 leads to inclusion of the entire storage area allowed to store information associated with processes required for the control operations in the RAM area 220.

Subsequently, it is checked at step S120 whether or not a notification signal has begun to be inputted from the power circuit 3. As described above, since the notification signal is a signal for notifying the controller 2 of being unable to normally perform the control operation corresponding to the notification signal, it is possible to indirectly determine whether or not the control operation can be normally performed by checking whether or not the notification signal has begun to be inputted at step 120.

While it is determined that no notification signal has begun to be inputted from the power circuit 3 at step S120, the controller 2 remains in the normal state. Once some notification signal has begun to be inputted from the power circuit 3 (“YES” at step S120), the entire storage area in the operation memory 23 allowed to store information associated with processes required for the control operations is set to be write-inhibited at step S130.

At step 130, as shown in FIG. 5B, the address information (a) initially stored in the address memory 31 is saved in the saving memory 33, and the address information (b) initially stored in the saving memory 33 is stored in the address memory 31. This leads to exchange between the address information (a) and (b) stored in the memories 31, 33.

The address information (b) stored in the saving memory 33 defines the entire storage area in the operation memory 23 allowed to store information associated with processes required for the control operations (address range b to a) as being included in the ROM area 210 that is write-inhibited. Therefore, the storage of the address information (b) in the address memory 31 leads to inclusion of the entire storage area in the operation memory 23 allowed to store information associated with processes required for the control operations in the write-inhibited area (see “SETTINGS OF STORAGE AREA” in FIG. 3).

Subsequently to step S130, it is checked at step S140 whether or not the input of the notification signal from the power circuit 3 has terminated. If the input of the notification signal from the power circuit 3 has not been terminated yet, then it is checked at step S150 whether or not the reset signal has been inputted from the power circuit 3.

If it is determined at step 150 that the reset signal has been inputted, the memory protecting process is immediately ended. On the other hand, the reset signal has not been inputted yet, the process returns to step S140.

If it is determined at step S140 that the input of the notification signal from the power circuit 3 has been terminated, the write-inhibited area set at step S130 is released at step 160, and then the process returns to step S120. The step S160 is prioritized over the other processes to be performed by the CPU 21. Therefore, even if any one of the other process is being performed, the release of the write-inhibited area is most preferentially performed as an interrupt process (see “SETTINGS OF STORAGE AREA” in FIG. 3).

In the present embodiment, the address information (b) in the address memory 31 is restored in the saving memory 33, and the address information (a) in the saving memory 33 is restored in the address memory 31. This allows the address information (a) and (b) to be exchanged between the both memories.

It should be noted that the address information (a) that has been stored in the saving memory 33 defines the entire storage area in the operation memory 23 allowed to store information associated with processes required for the control operations (address range b to a) as being included in the RAM area 220 when the controller can be normally driven. Therefore, the address information (a) restored in the address memory 31 can redefine the entire storage area in the operation memory 23 allowed to store information associated with processes required for the control operations as being included in the RAM area 220, which allows the write-inhibited area to be released.

In the present embodiment, as described above, the operations S120 to S160 are performed on the controller 2. It should be noted that the memory control circuit 25 may be responsible for the operations S140 and S160.

In the controller 2 of the present embodiment, once the controller 2 has returned to the normal state such that the control operations can be normally performed, the release of the write-inhibited area is most preferentially performed over the other processes to be performed by the CPU 21 as an interrupt process, which allows the storage of information associated with processes required for the control operations to be resumed immediately after the return to the normal state.

With this configuration, for example, when a learning value to be used as a result of each control operation in subsequent control operations is stored as information on the control operation, the subsequent control operations are allowed to be performed on the basis of the learning value indicative of the latest result after the return to the normal state.

In the above embodiment, when the release of the write-inhibited area is implemented in hardware by the memory control circuit 25 (i.e., the memory control circuit 25 is responsible for the operations S140 and S160 in FIG. 4), the memory control circuit 25 can resume the storage of information on the control operations in the operation memory 23 at the timing of return to the normal state. Since the memory control circuit 25 is stand-alone hardware, it is possible to resume the storage of information on the control operations immediately after the return to the normal state regardless of processing loads and priorities of the other processes.

In addition, with the hardware configuration as described above, when the operation memory 23 is changed into a write-enable state during a matching operation or the like, and then returned to the write-inhibited state after data rewriting, the operation memory 23 is allowed to return to the write-inhibited state without being attacked by the unauthorized access disguised as a software-based interruption with a higher priority, which leads to higher tamper-resistance against falsification of data by the unauthorized access.

In the present embodiment as described above, the entire storage area in the operation memory 23 allowed to store information associated with the control operations is changed from the RAM area 220 (the entire storage area is initially included in the RAM area 220) to the ROM area 210, which allows the entire storage area to be write-inhibited (see step S130 in FIG. 4). Subsequently, the entire storage area is returned from the ROM area 210 to the RAM area 220, which allows the write-inhibited area to be released (see step S160 in FIG. 4).

In this way, an address range defined by the address information initially stored in the address memory 31 is altered by replacing the address information initially stored in the address memory 31 with the address information initially stored in the saving memory 33, which allows the entire storage area allowed to store information associated with the control operations to be changed from the RAM area 220 to the ROM area 210. The entire storage area allowed to store information associated with the control operations can be returned from the ROM area 210 to the RAM area 220 at later timing of return to the normal state.

In the present embodiment as described above, when the entire storage area allowed to store information associated with the control operations is changed from the RAM area 220 to the ROM area 210, the address information initially stored in the address memory 31 is saved in the saving memory 33. The saved address information is then restored in the address memory 31, which allows the entire storage area to return from the ROM area 210 to the RAM area.

(Modifications)

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

In the above embodiment, the controller 2 is configured to indirectly determine whether or not the control operations can be normally performed on the basis of the notification signal from another monitoring entity (the power circuit 3 in the above embodiment) that monitors electrical power from the power supply source (the battery 140 in the above embodiment). Alternatively, the controller 2 may be configured to determine whether or not the control operations can be normally performed by the controller 2 directly monitoring the electrical power from the power supply source.

In the above embodiment, some operations (steps S140 and S160) of all the operations (steps S120 to S160) are implemented in hardware by the memory control circuit 25. Alternatively, all the operations from the determination (S120) of whether or not the notification signal has begun to be inputted to the release (S160) of the write-inhibited area may be implemented in hardware by the memory control circuit 25.

In the above embodiment, setting to and releasing the write-inhibited area (steps S130 and S160 in FIG. 4) are implemented by altering address ranges of the ROM area 210 and the RAM area 220 within the operation memory 23 that is a nonvolatile RAM. Alternatively, setting to and releasing the write-inhibited area may be implemented by suitable measures other than altering the address ranges of the ROM area 210 and the RAM area 220 within the operation memory 23.

In the above embodiment, the storage area allowed to store information on the control operations is changed from the RAM area 220 to the ROM area 210 by storing the address information initially stored in the saving memory 33 (the address information (b) in the above embodiment) in the address memory 31. Alternatively, address information for the storage area allowed to store information on the control operations to be set to the write-inhibited area may be generated and stored in the address memory 31.

### Second Embodiment

In the above embodiment, the power circuit 3 is configured to output the notification signal to the controller 2 in cases where the power circuit 3 determines that at least one of the control operations cannot be normally performed. Upon reception of the notification signal, the controller 2 sets the entire storage area within the RAM area 220 allowed to store information on the control operations to be write-inhibited.

In a second embodiment of the present invention, the power circuit 3 determines for each control operation whether or not the control operation can be normally performed, and outputs to the controller 2 a notification signal corresponding to a control operation determined to be unable to be normally performed. Upon reception of the corresponding notification signal, the controller 2 sets a storage area within the RAM area 220 allowed to store information on that control operation to be write-inhibited.

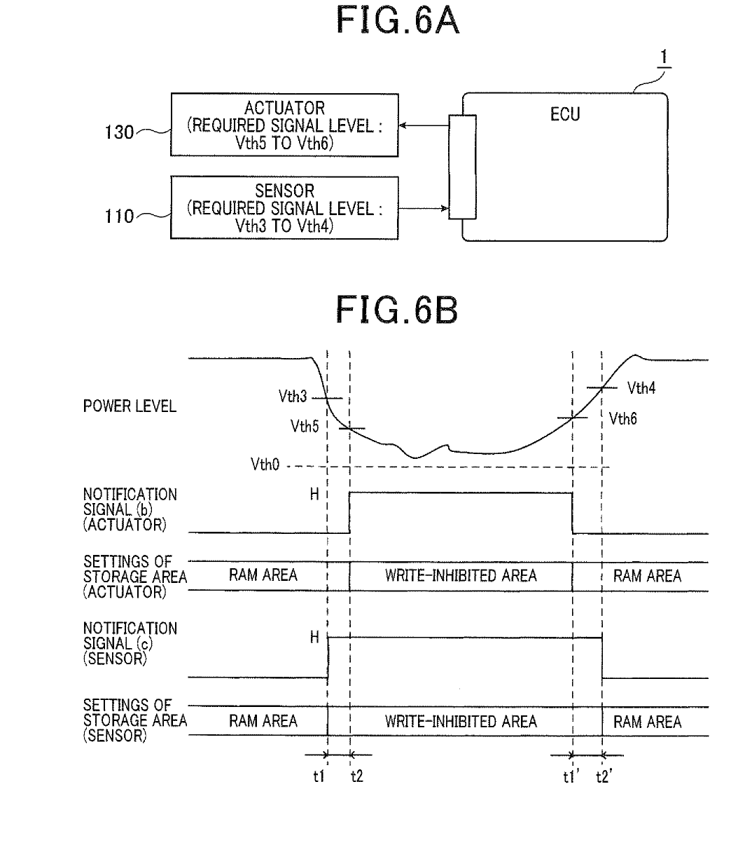

As an example, it can be assumed that the control operations include an output control operation accompanied by a process of storing an intermediate operation result for operating a certain actuator 130 or an operation result of the actuator 130 obtained by various Sensors as learning data in the RAM area 220 within the operation memory 23, and a detection control operation accompanied by a process of storing a detection value from a certain sensor 110 in the RAM area 220 within the operation memory 23. It can be further assumed that, as shown in FIG. 6A and FIG. 6B, a power level required for normal operation of the actuator 130 (Vth5 to Vth6) is below a power level required for normal detection of the sensor 110 (Vth3 to Vth4).

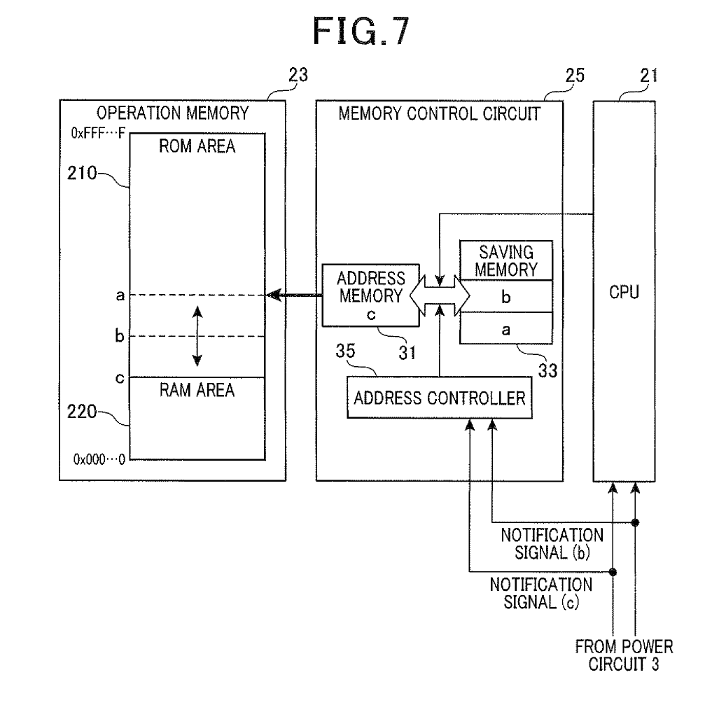

Under this assumption, as shown in FIG. 7, the power circuit 3 is configured to output distinct notification signals associated with different control operations (in FIG. 7, the control operations are provided with respective output pathways). Further, the saving memory 33 in the memory control circuit 25 may be a register for selectively writing therein and reading therefrom a plurality of pieces of address information such that there may be no correlation relation between the writing order into the register and the reading order from the register (in other words, the reading order may not be a function of the writing order). However, even in the presence of a correlation relation between the writing and reading orders, a queue or stack may be allowed in the present embodiment.

The plurality of pieces of address information include at least address information (a) that defines the ROM area 210 and the RAM area 220 in the normal state as described above in connection with the first embodiment, address information (b) that defines a storage area (address range b to a in FIG. 7) for the output control operation, and address information (c) that defines a storage area for the detection control operation (address range c to b in FIG. 7).

The memory protecting process of the present embodiment may be divided into two processes: the first memory protecting process and the second memory protecting process.

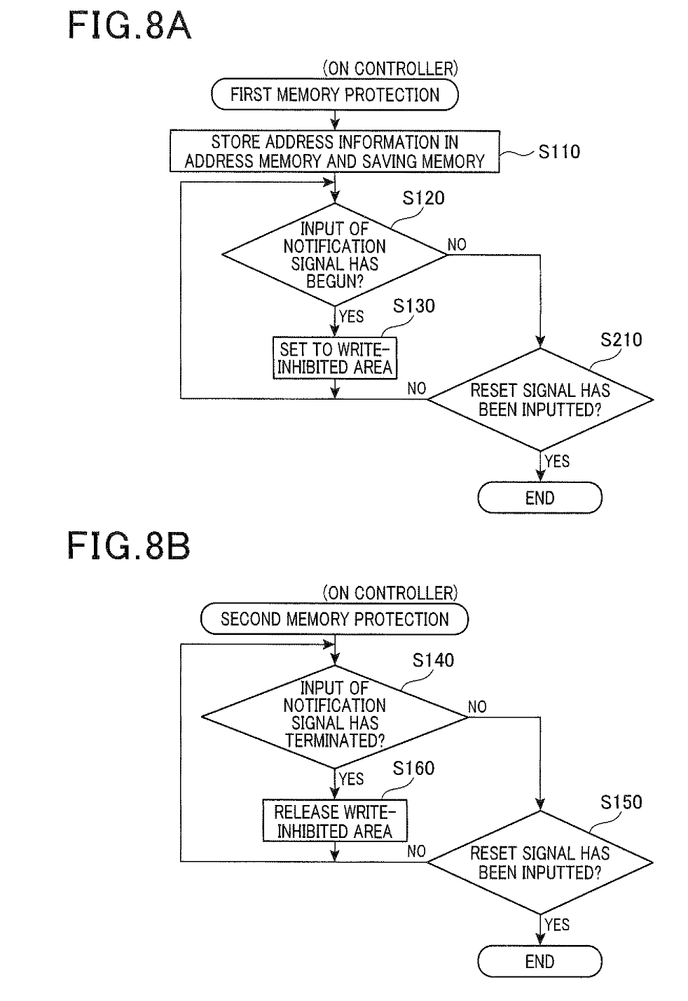

In the first memory protecting process, as shown in FIG. 8A, it is determined at step S120 whether or not a notification signal (either one or both of the notification signals (b) and (c) in the present embodiment) has begun to be inputted from the power circuit 3. If it is determined that a notification signal has begun to be inputted, the storage area allowed to store information on the control operation associated with the notification signal is set to be write-inhibited at step S130. The steps S120 and S130 are repeated until it is determined that the reset signal is inputted from the power circuit 3 at step S210.

On the other hand, in the second memory protecting process, as shown in FIG. 8B, it is determined at step S140 whether or not the input of the notification signal (either one or both of the notification signals (b) and (c) in the present embodiment) has been terminated. If it is determined that the input of the notification signal has been terminated, the write-inhibited area associated with that notification signal is released at step S160. The steps S140 and S160 are repeated until it is determined that the reset signal is inputted from the power circuit 3 at step S150.

With this configuration, it is possible to selectively set a portion of the entire storage area (address range c to a in FIG. 7) within the RAM area 220 allowed to store information on each control operation to be write-inhibited in cases where the control operation becomes unable to be normally performed. This can prevent the remaining portion(s) of the entire storage area within the RAM area 220 allowed to store information on the other control operations that can be normally performed from being set to be write-inhibited, thereby enabling only that portion of the entire storage area to be set to be write-inhibited and then released (see t1-t2 and t1′-t2′ in FIG. 6B where only the portion of the entire storage area allowed to store information on the output control operation is set to be write-inhibited).

What is claimed is:

1. A controller comprising:
an operation memory including a storage area for storing prescribed information associated with a control operation;
determining means for determining whether or not the control operation can be normally performed on the basis of a power level of electrical power supplied to the controller;
write-inhibiting means for setting the storage area in the operation memory to a write-inhibited area in cases where it is determined by the determining means that the control operation cannot be normally performed; and
releasing means for releasing, as an interrupt process higher in priority than any other process, the write-inhibited area in cases where it is determined by the determining means after the setting of the storage area to the write-inhibited area that the control operation can be normally performed.

2. The controller of claim 1, further comprising a control circuit including at least the releasing means, wherein the releasing mean releases the write-inhibited area as an interrupt process at the first timing that it is determined by the determining means after the setting of the storage area to the write-inhibited area by the write-inhibiting means that the control operation can be normally performed.

3. The controller of claim 1, wherein
the operation memory is a nonvolatile RAM in which both a ROM area for reading data only and a RAM area for writing and reading data can be variably defined, wherein the storage area is initially included not in the ROM area, but in the RAM area,
the write-inhibiting means sets the storage area to the write-inhibited area by altering initial address ranges for the RAM area and the ROM area so that the storage area is included not in the RAM area, but in the ROM area;
the releasing means releases the write-inhibited area by returning the altered address ranges to the initial address ranges for the RAM area and the ROM area in cases where it is determined by the determining means after the setting of the storage area to the write-inhibited area by the write-inhibiting means that the control operation can be normally performed.

4. The controller of claim 3, further comprising an address memory for initially storing first address information indicative of initial address ranges for the ROM area and the RAM area in the operation memory, wherein the storage area is included not in the ROM area specified by the first information, but in the RAM area specified by the first address information,
the write-inhibiting means sets the storage area to the write-inhibited area by altering the initial address ranges for the RAM area and the ROM area specified by the first address information initially stored in the address memory so that the storage area is included not in the RAM area, but in the ROM area after the alteration, and
the releasing means releases the write-inhibited area by returning the altered address ranges to the initial address ranges.

5. The controller of claim 4, further comprising a saving memory for initially storing second address information indicative of address ranges for the ROM area and the RAM area in the operation memory, wherein the storage area is included not in the RAM area specified by the second address information, but in the ROM area specified by the second address information,
the write-inhibiting means sets the storage area to the write-inhibited area by saving the first address information initially stored in the address memory in the saving memory and storing the second address information initially stored in the saving memory in the address memory,
the releasing means releases the write-inhibited area by returning the first address information stored in the saving memory to the address memory.

6. The controller of claim 3, wherein the operation memory is the address ranges comprise a border between the RAM area and the ROM area.

7. The controller of claim 1, wherein the prescribed information include at least one of a detection value from a sensor, a result value of the control operation, a learning value to be used as a result of the control operation in subsequent control operations, and failure information indicative of a failure that has occurred in a controlled object.

8. A controller comprising:
an operation memory including a storage area for storing prescribed information associated with a plurality of control operations;
determining means for determining whether or not the control operations can be normally performed on the basis of a power level of electrical power supplied to the controller;
write-inhibiting means for setting the entire storage area in the operation memory to a write-inhibited area in cases where it is determined by the determining means that at least one of the control operations cannot be normally performed; and
releasing means for releasing, as an interrupt process higher in priority than any other process, the write inhibited area in cases where it is determined by the determining means after the setting of the entire storage area to the write-inhibited area that the control operations can be normally performed,

9. A controller comprising:
an operation memory including a plurality of storage areas for storing prescribed information associated with a plurality of control operations;
determining means for determining whether or not the control operations can be normally performed on the basis of a power level of electrical power supplied to the controller;
write-inhibiting means for, in cases where it is determined by the determining means that at least one of the control operations cannot be normally performed, setting the storage area for the at least one of the control operation to a write-inhibited area; and
releasing means for releasing, as an interrupt process higher in priority than any other process, the write inhibited area in cases where it is determined by the determining means after the setting of the storage area to the write-inhibited area by the write-inhibiting means that the at least one of the control operation can be normally performed.

10. A method of inhibiting and resuming storage of prescribed information associated with a control operation to be performed on a controller in a storage area within an operation memory of the controller, the method comprising the steps of:
determining whether or not the control operation can be normally performed on the basis of a power level of electrical power supplied to the controller;
setting the storage area to a write-inhibited area in cases where it is determined that the control operation cannot be normally performed; and
releasing, as an interrupt process higher in priority than any other process, the write inhibited area in cases where it is determined after the setting of the storage area to be write-inhibited that the control operation can be normally performed.

11. An electric control unit (ECU) mounted in a vehicle that performs a control operation for controlling a actuator on the basis of an input signal from a sensor and/or switch, the ECU comprising:
an operation memory including a storage area for storing prescribed information associated with the control operation;
determining means for determining whether or not the control operation can be normally performed on the basis of a power level of electrical power of a vehicle battery as a power source for the ECU;
write-inhibiting means for setting the storage area in the operation memory to a write-inhibited area in cases where it is determined by the determining means that the control operation cannot be normally performed; and
releasing means for releasing, as an interrupt process higher in priority than any other process, the write inhibited area in cases where it is determined by the determining means after the setting of the storage area to the write-inhibited area that the control operation can be normally performed.

12. An electric control unit (ECU) mounted in a vehicle, comprising:
a power circuit that is supplied with electrical power from a vehicle battery as a power source for the ECU and outputs a power signal; and
a controller that receives the power signal and performs a control operation for controlling a actuator on the basis of an input signal from a sensor and/or switch,
wherein the power circuit comprises:
first determining means for determining whether or not the control operation can be normally performed on the controller on the basis of a power level of the electrical power from the battery, and
notifying means for notifying the controller via a notification signal that the control operation cannot be normally performed on the controller,
the controller comprises:
an operation memory including a storage area for storing prescribed information associated with the control operation;
second determining means for determining whether nor not the notification signal has begun to be inputted from the power circuit;
write-inhibiting means for setting the storage area in the operation memory to a write-inhibited area in cases where it is determined by the second determining means that the notification signal has begun to be inputted from the power circuit; and
releasing means for releasing, as an interrupt process higher in priority than any other process, the write inhibited area in cases where it is determined by the second determining means after the setting of the storage area to the write-inhibited area that the input of the notification signal has terminated.

13. The ECU of claim 12, further comprising an input-output circuit that relays the input signal from the sensor and/or switch to the controller and an output signal from the controller to the actuator.
